(19) United States
(12) Patent Application Publication
(10) Pub. No.: US 2015/0016937 A1
(43) Pub. Date: Jan. 15, 2015

(54) TRANSPORT DEVICE

(71) Applicants: Christoph Pedain, Waiblingen (DE); Timo Wilhelm, Ludwigsburg (DE)

(72) Inventors: Christoph Pedain, Waiblingen (DE); Timo Wilhelm, Ludwigsburg (DE)

(73) Assignee: Roche Diagnostics Operations, Inc., Indianapolis, IN (US)

(21) Appl. No.: 14/288,434

(22) Filed: May 28, 2014

(30) Foreign Application Priority Data
Jun. 4, 2013 (DE) 102013210372.7

(51) Int. Cl. B66C 1/10

(52) U.S. Cl. CPC B66C 1/10
USPC 414/785; 294/86.4; 294/192

(57) ABSTRACT

A device is presented in which individual sample containers can be conveyed from a start position to a target position. The role of start position and target position is interchangeable. The movement of a gripper is a combined lifting movement and translation movement. With the aid of a simple drive, the gripper is moved along a movement path that is mechanically defined.

### CROSS-REFERENCE TO RELATED APPLICATIONS

This application is a continuation of DE 10 2013 210 372.7, filed Jun. 4, 2013, which is hereby incorporated by reference.

### BACKGROUND

The present disclosure relates to a device in which a sample container, or a similar container, can be removed from a sample container carrier at a first location and can be transported to a sample container carrier at another location and set down there.

The first location can be referred to as the start position and the other location as the target position.

In this type of movement, a vertical movement component is needed both in the removal from the sample container carrier and also in the setting down.

One prior known device is a gripper which is able to take hold of and release containers and that can be moved in three dimensions. The gripper can be lifted in the vertical and, with the aid of a gantry, can be moved in any desired manner in one plane. However, at least three motors are needed for this purpose.

Additionally, a gripper that can take hold of containers in the form of tubes is likewise known. However, the outlay in terms of the mechanics and design of the known device is quite considerable, likewise the number of possible errors.

Therefore, there is a need for a device of the aforementioned type that can be produced with less outlay.

### SUMMARY

According to the present disclosure, a device for transferring and for transporting sample containers from a start position to a target position is presented. The device comprises a gripper adapted to grip the sample container, a gripper holder adapted to hold the gripper, a movement path determiner interacting mechanically with the gripper holder such that the gripper holder moves during a movement along a defined movement path, and a gripper holder drive adapted to effect a movement of the gripper holder.

Accordingly, it is a feature of the embodiments of the present disclosure to provide a device in which a sample container, or a similar container, can be removed from a sample container carrier at a first location and can be transported to a sample container carrier at another location and set down there such that the device can be produced with less outlay. Other features of the embodiments of the present disclosure will be apparent in light of the description of the disclosure embodied herein.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates a highly schematic view of a device according to a first embodiment of the present disclosure.

FIG. 2 illustrates shows a highly schematic view of a device according to a second embodiment of the present disclosure.

FIG. 3 illustrates an embodiment corresponding to FIG. 1 but modified in relation thereto.

FIG. 4 illustrates a highly simplified view of one end of a toothed rack for implementing a movement path of a device according to an embodiment of the present disclosure.

### DETAILED DESCRIPTION

In the following detailed description of the embodiments, reference is made to the accompanying drawings that form a part hereof, and in which are shown by way of illustration, and not by way of limitation, specific embodiments in which the disclosure may be practiced. It is to be understood that other embodiments may be utilized and that logical, mechanical and electrical changes may be made without departing from the spirit and scope of the present disclosure.

The device can serve for transferring and for transporting sample containers from a start position to a target position. The device can use a gripper, which can take hold of the sample, or the sample container such as, for example, a test tube, and can also release the sample or the sample container. The gripper can be mounted on a gripper holder which, with the aid of a drive, can move along a defined movement path.

A movement path determiner can be coupled mechanically to the gripper holder and can mechanically determine the movement path of the gripper holder and thus also of the gripper. The movement path can have horizontal and vertical components. The movement path can have (or be) a line of any desired shape in space. The movement path can be determined by the movement path determiner in such a way that the gripper can be moved during a movement along the movement path from the start position to the target position.

According to one embodiment, only a single such as, for example, an electric, drive is necessary in order to produce any desired travel profiles along the movement path with vertical and horizontal components.

In one embodiment, the movement path can have a single degree of freedom. The movement path can be determined or set based on the structural design of the movement path determiner in such a way that, during a movement of the gripper holder along the movement path, the gripper can be moved from the start position to the target position. With a unique start position and a unique target position, a single degree of freedom can suffice. The movement path can be, for example, a line of any desired curvature in space.

In a further embodiment, the gripper holder drive can have a single electric motor. This not only reduces the costs of production of such a device but can also reduce the maintenance costs and the repair costs. The number of possible errors can also decrease.

In one embodiment, a gripper actuator can be provided effecting a positive control caused by the movement of the gripper holder for the actuation of the gripper. This positive control can be triggered or actuated by the gripper holder and thus the gripper, reaching the start position or the target position during its movement. If, for example, the gripper is moved in the empty state to a sample container, it can be opened. As soon as it reaches the start position for the movement of the sample container, it can be closed by the positive control. It can thus take hold of the sample container.

By contrast, when the gripper reaches the target position together with a sample container, the positive control can open the gripper upon reaching the target position. It can thus release the sample container.

However, it can likewise be possible that the device can have a dedicated mechanism for the actuation of the gripper, for example a dedicated electric drive.

The movement that the gripper executes can be composed of a vertical lifting movement and of a horizontal translation movement. In one embodiment, the movement path determiner can be mechanically configured in such a way that the movement path can have, at least at one of its ends, a portion that can effect a vertical lifting movement. It can thus be ensured that the gripper at the start position and/or at the target position can execute a purely vertical movement. This may be necessary in order to lift a sample container out of a sample container carrier or to insert a sample container into a sample container carrier.

However, it can likewise be possible that the movement path determiner can be mechanically configured in such a way that the movement path can have, at least at one of its ends, a horizontal movement component. This type of design can facilitate the drive and can be feasible if, in order to lift the sample carrier out of the sample carrier or to set it down, only a very short vertical component can be needed or it can otherwise be ensured that the setting down or removal can be possible.

For this purpose, the device may have a drive for short-stroke movement or a change of the start position and/or the target position of the sample or of the sample carrier. Short stroke can be understood that the degree of possible movement may be small in relation to the actual movement path. The movement has to take place so as to permit the lifting of the sample container out of the sample container carrier and the setting down into the sample container carrier, respectively. The degree of possible movement may be provided in the same direction in which the transport movement takes place.

The movement path determiner can also be mechanically configured in such a way that the movement path can have exclusively vertical or horizontal components at one or both of its ends, i.e. that a purely vertical or purely horizontal movement of the sample container can be effected at one or both ends of the movement path.

In a further embodiment, the movement path determiner can be provided in the form of a guide rail along which the gripper holder for the gripper can travel with the aid of rollers, runners or the like. The guide rail can also be embodied as a toothed rack or as a stator of a linear motor.

A further possibility for implementing the movement path determiner can be that the movement can be effected by a device of mechanically coupled links.

The device for transferring and for transporting sample containers from a start position to a target position can have a gripper which can grip the sample container. Moreover, a gripper holder can be provided which can hold the gripper.

Moreover, the device can have a movement path for the sample container, wherein the sample container (to be gripped) can have a horizontal projection of the degrees of freedom of movement that the gripper holder can execute. In this way, the sample container can follow the moved gripper holder along the horizontal degrees of freedom of movement thereof, in a plane or horizontally.

The movement path can have a sensor that can ascertain the position of the sample container. The sensor can be read out during a movement of the sample container that can be induced by the movement of the gripper holder. The movement path can actively move the sample container. The movement path can be switched such that no horizontally directed force can be applied to the sample container. The movement path can be designed such that a vertical force can be applied to the sample container.

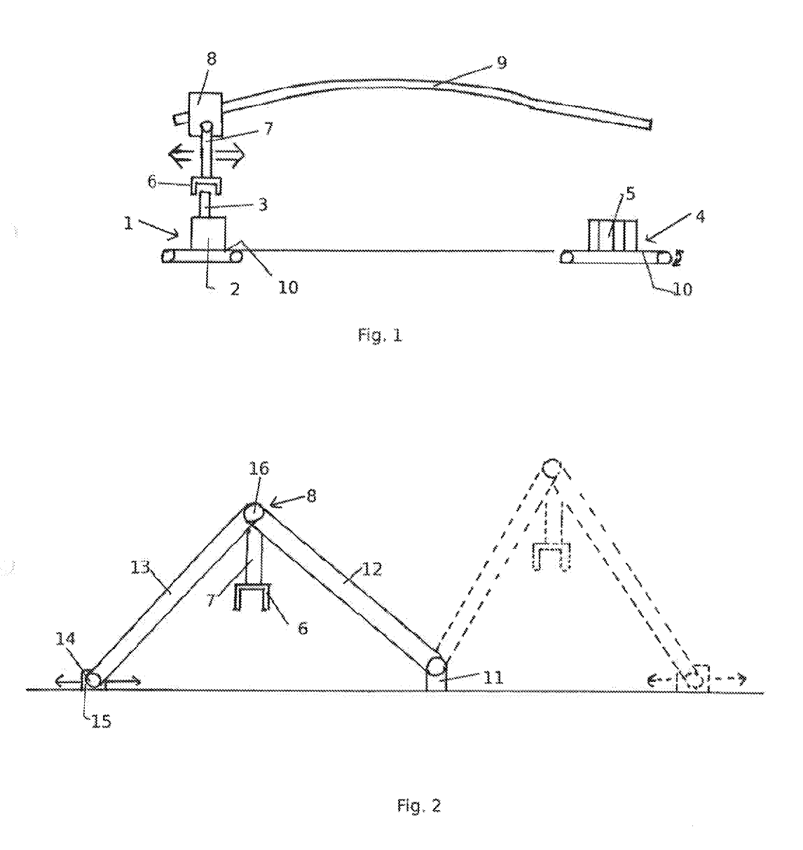

Referring initially to FIG. 1, FIG. 1 is a highly schematic representation of how a device can be constructed and how it can be used. A sample container carrier 2 can be provided in the start position 1 shown on the left-hand side. A sample container 3 (for example in the form of a test tube) can be fitted in the sample container carrier 2. The right-hand side of FIG. 1 shows the target position 4, at which a sample container carrier 5 can likewise be provided. The sample container carrier 5 can serve to receive a plurality of sample containers 3 and can be embodied, for example, as a rack. The device can transport a sample container 3 from the sample container carrier 2 provided in the start position 1 to the sample container carrier 5 in the target position 4. It can, of course, also be able to bring a sample container 3 from the target position, which can then become the start position, back to the start position, which can then become the target position.

The device can comprise a gripper 6. The gripper 6 is shown schematically. The gripper can be able to secure and release a sample container 3. The gripper 6 can be suspended so as to oscillate on a gripper holder 8 with the aid of a rod 7. By a guide, the gripper holder 8 can be guided on a movement path determiner in the form of a rail 9 and can be displaced along the rail 9. This can be affected with the aid of rollers, wheels, runners or the like. In its end area assigned to the start position 1, the rail 9 can have an obliquely upwardly directed profile, i.e. the rail 9 can have both a horizontal and also a vertical profile component. The rail 9 can be fixed in position and can extend in a shallow arc to its second end assigned to the target position 4, where it can likewise adopt an oblique profile. The rail 9 can thus define a movement path for the gripper holder 8.

The device can comprise an electric drive (not shown) which can displace the gripper holder 8, and therefore the gripper 6 can be suspended thereon, along the rail 9. For example, this can be a cable pull coupled to an electric motor and engaging on the gripper holder 8. The possible movements of the drive are shown by the double arrow. If the drive is now started up, starting from the position 1 in FIG. 1, the gripper 6 can be displaced upwards and to the right until it can finally be lowered again at the second end of the rail 9.

The gripper 6 can have two stable states, namely an opened state and a closed state. In the closed state, it can hold the sample container 3 securely, while in the opened state the sample container 3 can be released. To transport the sample container 3 starting from the position 1 in FIG. 1, the gripper can close and thus grip the sample container 3. It can then move to the right by the drive until it arrives at its end position. In the end position, the gripper 6 can be opened by a positive control. The sample container 3 can thereby be released.

Since the sample container carrier 2 or 5 can also laterally support the sample container, and since a horizontal movement component of the gripper 6 can be allowed both in the start position 1 and also in the target position 4, the sample container carrier 2 or 5 can follow the horizontal movement of the gripper 6 by a short distance in order to compensate for this horizontal movement component. For this purpose, the two sample container carriers 2 and 5 can be arranged on a platform 10, for example, which can execute a short-stroke movement in the transport direction. This is indicated in FIG. 1 by a short transport belt. In this way, the respective sample container carrier 2, 5 can be displaced a short distance in the transport direction.

FIG. 2 shows a second embodiment of a device with a modified type of movement control. A first link 12 can be mounted pivotably around a horizontal axis on a stationary abutment 11. At its end directed away from the stationary abutment 11, the link 12 can be connected to a second link 13 likewise pivotably around a horizontal axis. In this embodiment, the second link 13 can have the same length as the first link 12.

The free end 14 of the second link 13 can be connected pivotably to a drive bearing 15. The drive bearing 15 can be guided linearly displaceably in the plane on which the abutment 11 can be arranged and can be provided with a drive that can displace this drive bearing 15 linearly in both directions. The displaceability can also extend beyond the abutment 11. This can be achieved by the drive bearing 15 arranged behind the plane in which the abutment 11 can be arranged.

The gripper holder 8, on which the gripper 6 can be suspended via the connecting rod 7, can be arranged at a connection site 16 between the two links 12 and 13. Upon displacement of the drive bearing 15 in the direction of the indicated arrows, the gripper 6 can execute a movement corresponding to an arc of a circle. In this way, the gripper 6, and with it a sample container 3, can be transferred from a start position to a target position.

The broken lines in FIG. 2 show the position that can be adopted by the two links 12, 13 when the drive bearing 15 is displaced to the right past the fixed abutment 11.

Since the gripper 6 of the device in FIG. 2 can also execute a movement with a horizontal component in the start position and in the target position, a compensation can also be provided in the device of FIG. 2 with the aid of the displaceability of the sample container carriers 2, 5 receiving the sample containers 3. In the embodiment of FIG. 2, such a compensation can also be provided by the inherently fixed abutment 11 executing this short-stroke movement.

In the embodiment in FIG. 2, it can likewise be possible for the stationary bearing of the first link 12 in the abutment 11 to be arranged higher, i.e. at a greater distance from the plane on which the sample containers 2, 5 can stand. If the distance of the bearing axis in the stationary abutment 11 and the length of the rod 7 connecting the gripper 6 to the gripper holder 8 can be adapted to each other such that the link 12 can extend horizontally in the receiving position of the gripper 6 for the corresponding sample container 2, 5, the movement of the gripper 6 can begin with an exclusively vertical movement component. In this case, a corresponding compensation by a short-stroke horizontal movement of the sample container carriers 2, 5 or of the abutment 11 may not be necessary.

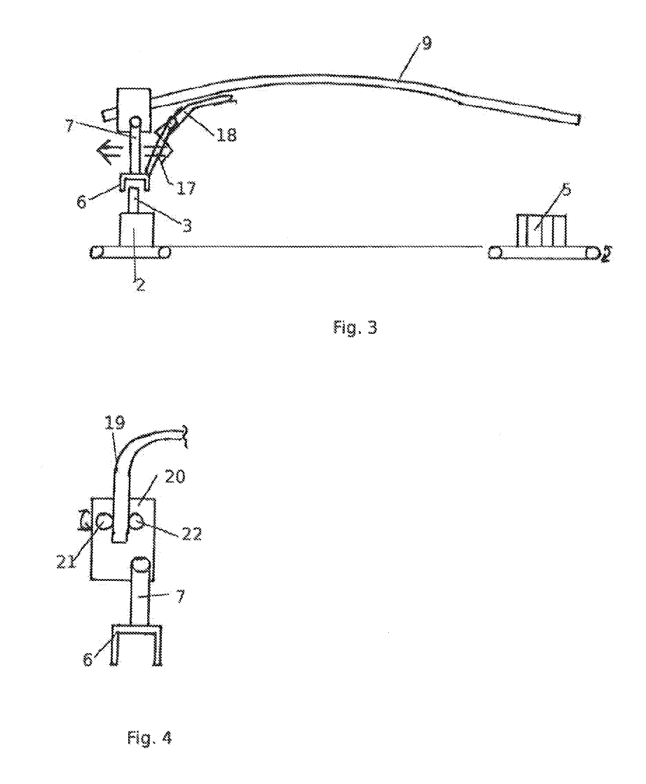

FIG. 3 shows an embodiment that is slightly modified in relation to FIG. 1. Here, in order to control the gripper 6, a link 17 can be provided which can interact with a dedicated guide rail 18. This guide rail 18 can have a different profile than the rail 9. The link 17 and the guide rail 18 can actuate the gripper 6 when the start position 1 or target position 4 is reached. Since the gripper 6 can be intended to be opened or closed depending on its state, and since the start position 1 and target position 4 can be interchangeable because of the transport in both directions, the different control of the gripper can be achieved for example via a switching point in the guide rail 18.

For example, the guide rail 18 for the link 17 for actuating the gripper or a part of the gripper can extend over most of its extent parallel to the rail 9 and can have a deviating course only in the end area where the control of the gripper 6 is to be influenced. Since the mechanically defined movement path, in this case determined by the rail 9, can have a defined start position and a defined target position, a direct mechanical control can also be used as positive control for the actuation of the gripper 6.

In FIGS. 1-3, the sample container carriers 2, 5 are shown in one plane. However, the device can also be used to transfer samples or sample containers from a start position to a target position when both may be arranged not at the same height but at different height levels. Grippers can also be moved that can take hold of and transport more than one sample container 3.

FIG. 4 shows a detail, namely an end of a guide rail, which can be designed as a toothed rack 19. For example, the toothed rack 19 can have teeth on the left and upper side in FIG. 4, whereas it can be smooth on the opposite side. The gripper holder 20 can have a toothed wheel 21, which can engage with the teeth of the toothed rack 19. A pressing wheel 22 can be arranged rotatably on the opposite side, such that the toothed rack 19 can pass between the toothed wheel 21 on the one hand and the pressing wheel 22 of the gripper holder 20 on the other hand. In this way, the gripper holder 20 can be secured on the toothed rack 19. An electric motor that can drive the toothed wheel 21 in rotation can therefore serve for drive purposes. This can likewise be a possibility in which the end of the movement path may be vertical.

One or more sample containers can be transported from a start position to a target position. The role of start position and target position can be interchangeable. The movement of a gripper can be a combined lifting movement and translation movement. With the aid of a simple drive, the gripper can move along a movement path that can be mechanically defined.

It is noted that terms like “preferably,” “commonly,” and “typically” are not utilized herein to limit the scope of the claimed embodiments or to imply that certain features are critical, essential, or even important to the structure or function of the claimed embodiments. Rather, these terms are merely intended to highlight alternative or additional features that may or may not be utilized in a particular embodiment of the present disclosure.

Having described the present disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

We claim:

1. A device for transferring and for transporting sample containers from a start position to a target position, the device comprising:
a gripper adapted to grip the sample container;
a gripper holder adapted to hold the gripper;
a movement path determiner interacting mechanically with the gripper holder such that the gripper holder moves during a movement along a defined movement path; and
a gripper holder drive adapted to effect a movement of the gripper holder.

2. The device according to claim 1, wherein the movement path has a single degree of freedom.

3. The device according to claim 1, wherein the gripper holder drive comprises a motor.

4. The device according to claim 1, further comprising,
a gripper actuator adapted to effect an actuation of the gripper in response to a movement of the gripper holder.

5. The device according to claim 1, wherein the movement path has a vertical component at at least one of its ends.

6. The device according to claim 1, wherein the movement path has a horizontal component at at least one of its ends.

7. The device according to claim 6, further comprising,
a drive adapted to change the start position and/or the target position of the sample container to compensate for the horizontal component of the movement path.

8. The device according to claim 1, wherein the movement path determiner comprises a guide rail.

9. The device according to claim 1, wherein the movement path determiner comprises a device of mechanically coupled links.

10. The device according to claim 1, wherein the gripper is adapted to grip a plurality of sample containers.
